(19) United States
(12) Patent Application Publication
(10) Pub. No.: US 2014/0159877 A1
(43) Pub. Date: Jun. 12, 2014

(54) BLUETOOTH CONTROLLABLE ELECTRICAL APPLIANCE

(71) Applicant: Jung-Tang Huang, Taipei (TW)

(72) Inventor: Jung-Tang Huang, Taipei (TW)

(21) Appl. No.: 13/707,635

(22) Filed: Dec. 7, 2012

(30) Foreign Application Priority Data
Dec. 7, 2012 (TW) 100223057

(51) Int. Cl. G08C 17/02

(52) U.S. Cl. CPC G08C 17/02
USPC 340/12.5

(57) ABSTRACT

The present invention provides a Bluetooth controllable electrical appliance, comprising: a circuit substrate; a Bluetooth communication chip disposed on the circuit substrate, wherein the Bluetooth communication chip is compatible with a Bluetooth 4.0 or later protocol; a microcontroller disposed on the circuit substrate and electrically connected to the Bluetooth communication chip, for receiving a command from the external remote controller; an AC to DC circuit disposed on the circuit substrate; and one or more actuators selected from the group consisting of a motor, a heating coil, resistor or transistor, and a combination thereof.

### TECHNOLOGY FIELD

The present invention relates to an electrical appliance, particularly an electrical appliance having a built-in Bluetooth communication chip compatible with a Bluetooth 4.0 or later protocol, combined with a microcontroller supplying at least one output selected from the group consisting of a PWM output, a DAC command output and a digital switch output, said microcontroller being connected to a power amplifier to drive a actuator of the electrical appliance.

### BACKGROUND OF THE INVENTION

For a long time, home electrical appliances, except air-conditioners, TVs, VCRs, DVD players, VCRs, massage chairs, etc., are lack of remote control function, let alone being able to be set and monitored through the internet. Further, the remote controls, most of which use infrared (IR), are often lost or failed, and the failure is often not easy to repair. However, mobile devices like mobile phones and tablets rarely support IR communication interface, while most of them support Bluetooth and WIFI communication interfaces. A comparison of IR communication and Bluetooth communication is as follows:

(A) IR communication: using light, 115.2 Kbps˜16 Mpbs (data rate), short distance (transmission distance ˜10 M), maximal transmission angle ˜120 degree, unable to transmit through solid objects, low power consumption, lack of security mechanism, and one-to-one; (B) Bluetooth 2.0 or 3.0 wireless communication: using radio wave, using the 2.4 GHz frequency band, supporting fast frequency hopping, low output power, low power consumption, low cost, 1-10 Mbps (data rate), 100 meters transmission distance, high popularization, one-to-many, no direction limitation, and low-cost chip.

Compared to Bluetooth 2.0 or 3.0 mentioned above, Bluetooth 4.0 further has the following advantages: link time as short as 7.5 milliseconds, lower power consumption, and lower cost.

Therefore, it is an object of the present invention to provide a Bluetooth controllable electrical appliance compatible with a Bluetooth 4.0 or later protocol. In this way, the various remote controls for home appliance can be unified to be such as a mobile phone or a tablet.

### BRIEF SUMMARY OF THE INVENTION

In one aspect, the present invention provides a Bluetooth controllable electrical appliance, comprising:
a circuit substrate;
a Bluetooth communication chip disposed on the circuit substrate, wherein the Bluetooth communication chip is compatible with a Bluetooth 4.0 or later protocol and is able to communicate with an external remote controller compatible with the Bluetooth 4.0 or later protocol;
a microcontroller disposed on the circuit substrate and electrically connected to the Bluetooth communication chip, for receiving a command from the external remote controller via the Bluetooth communication chip and reporting a status of use of the Bluetooth controllable electrical appliance, wherein the microcontroller supplies at least one output selected from the group consisting of a PWM output, a DAC command output and a digital switch output;
an AC to DC circuit disposed on the circuit substrate, for converting AC electricity supplied to the Bluetooth controllable electrical appliance to the DC electricity required by the Bluetooth communication chip and the microcontroller; and one or more actuators selected from the group consisting of a motor, a heating coil, resistor or transistor, and a combination thereof, wherein the one or more actuators are connected to and driven by a power amplifier or a relay, the power amplifier or the relay being regulated by the at least one output supplied by the microcontroller.

In another aspect, the present invention provides a Bluetooth controllable electrical appliance, comprising:
a circuit substrate;
a Bluetooth communication chip disposed on the circuit substrate, wherein the Bluetooth communication chip is compatible with a Bluetooth 4.0 or later protocol and is able to communicate with an external remote controller compatible with the Bluetooth 4.0 or later protocol;
a microcontroller disposed on the circuit substrate and electrically connected to the Bluetooth communication chip, for receiving a command from the external remote controller via the Bluetooth communication chip and reporting a status of use of the Bluetooth controllable electrical appliance, wherein the microcontroller supplies at least one output selected from the group consisting of a PWM output, a DAC command output and a digital switch output; and
an AC to DC circuit disposed on the circuit substrate, for converting AC electricity supplied to the Bluetooth controllable electrical appliance to the DC electricity required by the Bluetooth communication chip and the microcontroller.

The Bluetooth controllable electrical appliance of the present invention, which is compatible with a Bluetooth 4.0 or later protocol, can be remotely controlled by a mobile phone or a tablet, and can connect to the internet via a gateway and a router compatible with Bluetooth 4.0 or later protocol. Thus, the following improvements can be achieved by the present invention:
1. Real-time internet monitoring of home appliance: The information of the electrical appliances at home can convey to a distant user by Bluetooth 4.0 (or later) transmission.
2. Wireless: Bluetooth communication is wireless and safer. Since electrical appliances are placed in the living areas of the house, wireless transmission is concise and safer.
3. Graphic use interface: The control, setting and monitoring of the electrical appliance through graphic user interface of a mobile phone or a tablet are simple, intuitive and not language-restrictive.
4. Web-based control: Web-based control can also be achieved since mobile devices today allow users to access the internet easily.

The details of one or more embodiments of the invention are set forth in the description below. Other features or advantages of the present invention will be apparent from the following detailed description of several embodiments, and also from the appending claims.

### BRIEF DESCRIPTION OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

In the drawings:

FIG. 1 is a system architecture diagram of a Bluetooth controllable electrical appliance of the present invention.

FIG. 2 is a WIFI-based light source system according to the present invention.

FIG. 3 is a summary circuit diagram of application of a Bluetooth control reference board on a lamp switch, a heater or an electric fan.

FIG. 4A illustrates many control Apps in the graphic user interface of a smart phone for Bluetooth controllable electrical appliances of the present invention. FIG. 4B shows a graphic user interface of a control App with a temperature display and setting screen for a Bluetooth controllable air-conditioner. FIG. 4C shows a graphic user interface of a control App with an air volume display setting screen for a Bluetooth controllable air-conditioner.

FIG. 5A is block schematic diagram of an air-conditioner. FIG. 5B is block schematic diagram of a Bluetooth controllable air-conditioner of the present invention.

FIG. 6A is block schematic diagram of a dehumidifier. FIG. 6B is block schematic diagram of a Bluetooth controllable dehumidifier of the present invention.

FIG. 7 is block schematic diagram of a Bluetooth controllable refrigerator of the present invention.

### DETAILED DESCRIPTION OF THE INVENTION

Unless defined otherwise, all technical and scientific terms used herein have the same meanings as is commonly understood by one of skill in the art to which this invention belongs.

As used herein, the articles “a” and “an” refer to one or more than one (i.e., at least one) of the grammatical object of the article. By way of example, “an element” means one element or more than one element.

The present invention is further illustrated by the following descriptions, which are intended for mere demonstration and explanation but not limitation of the present invention to specific forms. The present invention envisions other variations in addition to those described herein. It is believed that those skilled in the art can achieve the whole scope of the present invention based on the descriptions herein.

In one aspect, the present invention provides a Bluetooth controllable electrical appliance, comprising:
a circuit substrate;
a Bluetooth communication chip disposed on the circuit substrate, wherein the Bluetooth communication chip is compatible with a Bluetooth 4.0 or later protocol and is able to communicate with an external remote controller compatible with the Bluetooth 4.0 or later protocol;
a microcontroller disposed on the circuit substrate and electrically connected to the Bluetooth communication chip, for receiving a command from the external remote controller via the Bluetooth communication chip and reporting a status of use of the Bluetooth controllable electrical appliance, wherein the microcontroller supplies at least one output selected from the group consisting of a PWM output, a DAC command output and a digital switch output;
an AC to DC circuit disposed on the circuit substrate, for converting AC electricity supplied to the Bluetooth controllable electrical appliance to the DC electricity required by the Bluetooth communication chip and the microcontroller; and
one or more actuators selected from the group consisting of a motor, a heating coil, resistor or transistor, and a combination thereof, wherein the one or more actuators are connected to and driven by a power amplifier or a relay, the power amplifier or the relay being regulated by the at least one output supplied by the microcontroller.

In some embodiments of the present invention, the one or more actuators are one or more motors, and the Bluetooth controllable electrical appliance is an appliance selected from the group consisting of an electric fan, a dehumidifier, an air cleaner, an air conditioner, a juice machine, a vacuum cleaner, a refrigerator, a dishwasher, a microwave oven, an electric curtain, an electric bed, an elevator, an electric door, and an electric massage chair.

In some other embodiments of the present invention, the one or more actuators are one or more heating coils, resistors or transistors, and the Bluetooth controllable electrical appliance is an appliance selected from the group consisting of a microwave, a lamp, a LED lamp, an electric cooker, an electric oven, and an induction cooker.

According to the present invention, the external remote controller compatible with the Bluetooth 4.0 or later protocol may be a device selected from the group consisting of a mobile phone, a tablet computer, a laptop computer, and a desktop computer, said device having an App for remote controlling installed therein.

In certain embodiments of the present invention, the Bluetooth controllable electrical appliance further comprises a feedback sensor selected from the group consisting of an encoder, a thermometer, a tachometer, a hygrometer, an illuminance meter, and a microphone.

According to one embodiment of the present invention, the Bluetooth controllable electrical appliance is a LED light source and the microcontroller have a control program installed therein, said control program providing a feedback signal to the external remote controller via a gateway and a router compatible with Bluetooth 4.0 or later protocol communication and WIFI communication.

In preferred embodiments of the present invention, the Bluetooth communication chip and the microcontroller are integrated in a system on chip (SOC).

In another aspect, the present invention provides a Bluetooth controllable electrical appliance, comprising:
a circuit substrate;
a Bluetooth communication chip disposed on the circuit substrate, wherein the Bluetooth communication chip is compatible with a Bluetooth 4.0 or later protocol and is able to communicate with an external remote controller compatible with the Bluetooth 4.0 or later protocol;
a microcontroller disposed on the circuit substrate and electrically connected to the Bluetooth communication chip, for receiving a command from the external remote controller via the Bluetooth communication chip and reporting a status of use of the Bluetooth controllable electrical appliance, wherein the microcontroller supplies at least one output selected from the group consisting of a PWM output, a DAC command output and a digital switch output; and
an AC to DC circuit disposed on the circuit substrate, for converting AC electricity supplied to the Bluetooth controllable electrical appliance to the DC electricity required by the Bluetooth communication chip and the microcontroller.

In certain embodiments of the present invention, the Bluetooth controllable electrical appliance is selected from the group consisting of a Stereo, a TV, a DVD player, a VCR, a karaoke OK, a projector, and a set-top box.

According to the present invention, the external remote controller compatible with the Bluetooth 4.0 or later protocol is a device selected from the group consisting of a mobile phone, a tablet computer, a laptop computer, and a desktop computer, said device having an App for remote controlling installed therein.

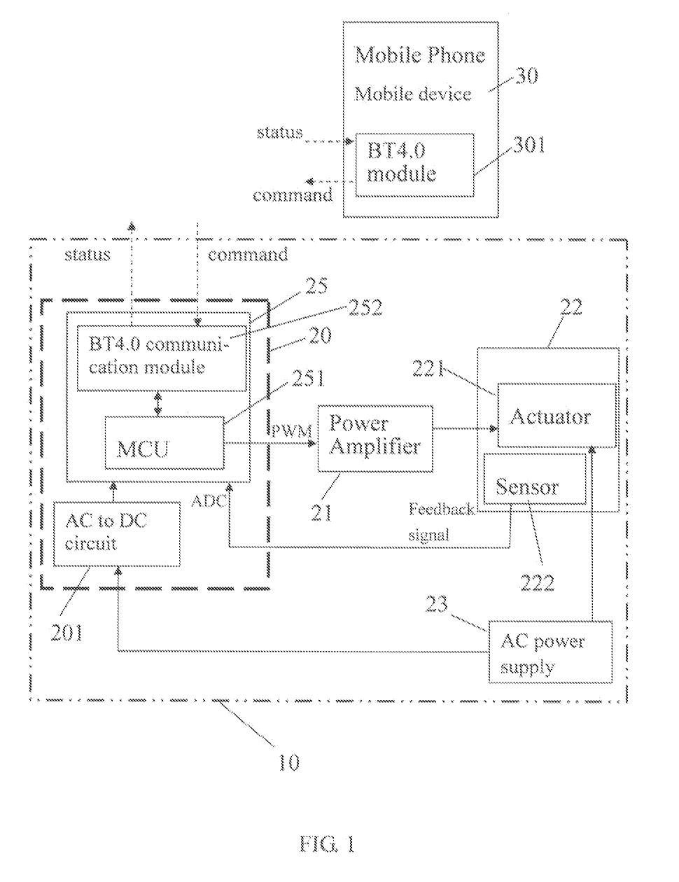

As shown in FIG. 1, electrical appliance 10 comprises a Bluetooth control reference board 20, at least one power amplifier or electromagnetic switch 21, a controlled mechanism 22 (including at least one actuator 221 and at least one sensor 222), and a AC power supply 23. The reference board 20 comprises a Bluetooth 4.0 communication module 252, a microcontroller (MCU) 251, an AC to DC circuit 201 for supplying DC electricity to the Bluetooth 4.0 communication module 252 and the microcontroller (MCU) 251. The Bluetooth 4.0 communication module 252 and the microcontroller (MCU) 251 may be integrated in a system on chip (SOC) 25. Preferred embodiments of the present invention use CC2540 BLE or CC2560 (dual mode BR/EDR) (Texas Instruments). They are 40-pin chips having BLE and MCU, said MCU supporting a PWM output to the at least one power amplifier or electromagnetic switch 21, and supporting at least one ADC input or counter input for receiving a status of operation of the controlled mechanism 22, e.g., rotation speed, temperature, humidity, brightness, volume, etc., from the sensor 222 and reporting the same. Artificial intelligence (fuzzy control) may be further introduced into the MCU for monitoring the electrical appliance.

Commands may be given from a mobile device 30 through its Bluetooth 4.0 communication module 301 to the electrical appliance 10, and a status of operation of the electrical appliance 10 may also be read from the mobile device 30. Further, one may control the electrical appliance 10 using the mobile device 30 through voice commands, e.g., giving voice commands through Siri of iPhone 4S for controlling the electrical appliance 10 compatible with Bluetooth 4.0.

For different electrical appliances, different carrier boards may be designed for the Bluetooth control reference board 20, said carrier boards are loaded with corresponding power amplifiers, and when necessary, feedback sensors. Home electrical appliances, such as electric fans, dehumidifiers, air conditioners, juice machines, vacuum cleaners, refrigerators, dishwashers, microwave ovens, electric curtains, electric beds, elevators, electric doors, air cleaners, electric massage chair, etc., have at least one actuator being a motor or a compressor. For example, microwave ovens, lamps, LED lamps, electric cookers, electric ovens, induction cookers, etc., all possess at least at least one actuator selected from the group consisting of a heating coil, resistance, or transistor, etc. For multimedia entertainment equipments, such as TVs, stereos, karaoke OKs, DVD players, VCR, projectors, set-top boxes, etc., which are conventionally remotely controlled by a IR remote control, their IR communication interfaces can be replaced by Bluetooth 4.0 communication interfaces directly.

Basically, the above-mentioned electrical appliances can be designed to be compatible with a Bluetooth 4.0 communication protocol. The electrical appliances may be set to slave operating mode, and the mobile devices may be set to master operating mode.

Connection times for Bluetooth 2.0 or 3.0 require a several seconds, which is much slower as compared to IR communication. While the connection interval for BLE Bluetooth 4.0 is as short as 7.5 milliseconds (Texas Instruments CC2540 Bluetooth® Low Energy Software Developer's Guide v1.0, 2010). It basically complies with the formula below:

Effective Connection Time=(Connection Interval)*(1(Slave Latency))

The Connection Interval can range from a minimum value of 6 (7.5ms) to a maximum of 3200 (4.0s); The Salve Latency can range from a minimum of 0 to a maximum of 499.

Therefore, the BLE Bluetooth 4.0 used in the present invention can provide a better and faster user experience than the IR remote control. Furthermore, the communication between the electrical appliance and the mobile device can be two-way, not only one-way as for IR communication. That is to say, feedback from the electrical appliance on failure, prolonged use or anything detected by a sensor can be send back to the mobile device, notifying necessary adjustment or troubleshooting.

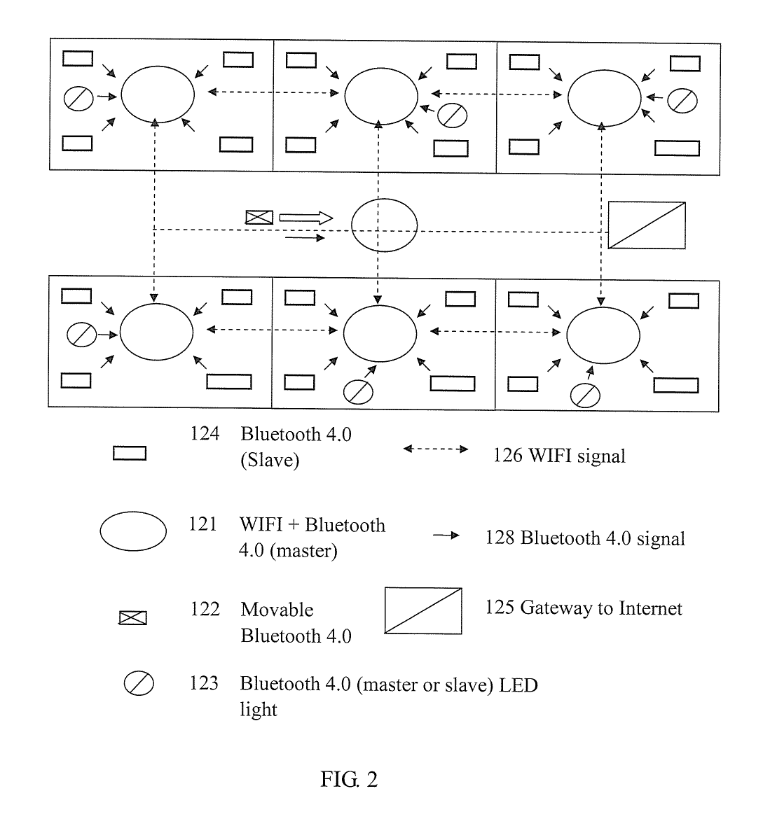

FIG. 2 illustrates another embodiment of the present invention. FIG. 2 is a system architecture diagram of a WIFI-based Internet of Things (IoT) light source system. The building interior light sources are partly or totally replaced by IoT light sources. The IoT light sources may be generally divided into three operating modes. In the first operating mode, an IoT light source, which operates as a slave node 123 purely, comprises a module composed of a BLE chip and a microprocessor, e.g. CC2540/2541 SOC (Texas Instruments) that supports Bluetooth 4.0 communication, a 8051 microprocessor, a ADC converter, and eight sensing signal inputs. In the second operating mode, an IoT light source may operate as a router 121 for integrating a WIFI/Bluetooth 4.0 integrated chip and a MCU, said MCU preferably being ARM9, or CC3000, CC2540/2541 or CC2560 (Texas Instruments). The Bluetooth 4.0 chip, serving as a master node or a slave node, may communicate or exchange Bluetooth 4.0 signals 128 with a light source 123 having a slave node or master node, an electrical appliance 124, or a distant user 122. WIFI also refers to Wi-Fi Direct, which allows direct communication with WIFI signal 126 between devices without an access point. As for the third operating mode, a desktop computer, a laptop computer, or a tablet computer, etc. may be built-in with the WIFI/Bluetooth 4.0 integrated chip and serves as a gateway 125 and may access Cloud Computing Service easily. The integrated chip uses fast Bluetooth technology and is able to connect through Wi-Fi and preforms Bluetooth Application Services at Wi-Fi speed. In summary, by installing a control program of electrical appliance 124 on the microcontrollers of the LED light sources 123 and 124, the electrical appliance 124 at home can be remotely controlled by a mobile phone 125, or controlled through the internet via the LED light sources 123 and 124.

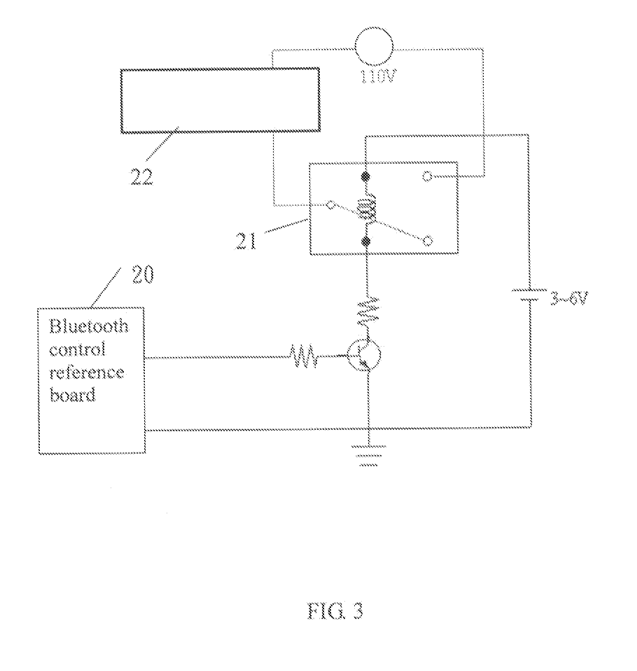

FIG. 3 illustrates a control drive circuit of a LED light source, an electric heater or an electric fan. When a transmitting end mobile device (not shown) transmits a signal, the pins of the Bluetooth control reference board 20 at the receiving end show high/low potential levels and generate an electric current which is then amplified by a power transistor to drive a relay, the relay being serving as a power switch for remote control of the electric appliances, e.g., fluorescent lights, LED lights, heaters or fans, etc. In addition, if the relay is replaced by a power amplifier or an inverter etc., dimming or toning of the fluorescent lights and LED lights, temperature adjustment of the heater, and adjustment of the fan rotation speed can be controlled by the PWM output signals of the Bluetooth control reference board 20. Further, a schedule program for lamp may be installed on the Bluetooth control reference board 20 to control the scheduled on/off of lamps.

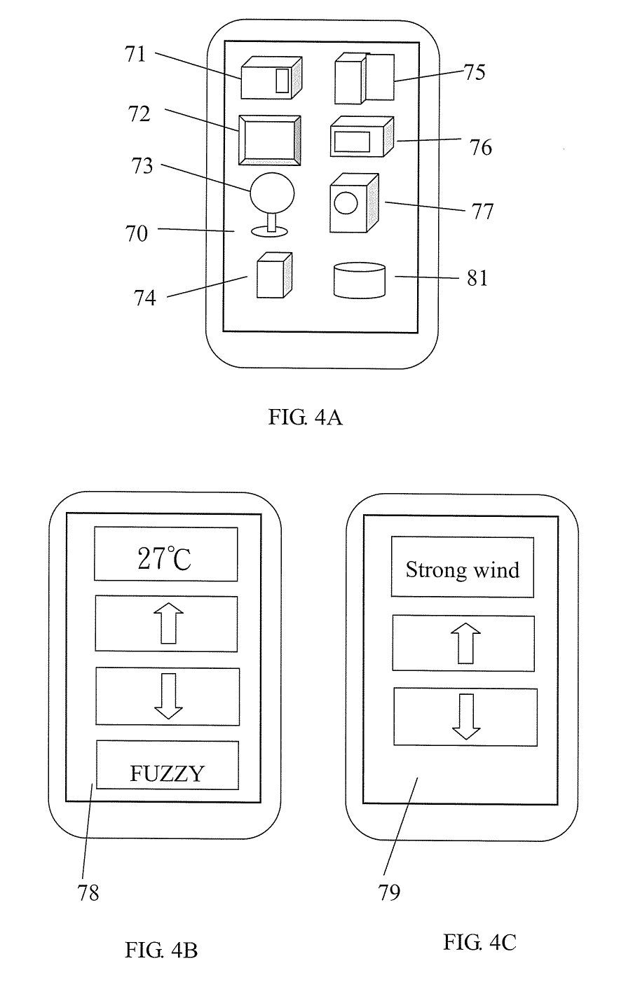

A user may control the electrical appliance at home through the touch screen of a smart phone. As shown in FIG. 4A, there are many control Apps in the graphic user interface 70, for example, an App 71 for air-conditioner, an App 72 for TV, an App 73 for fan, an App 74 for dehumidifier, an App 75 for refrigerator, an App 76 for microwave oven, an App 77 for washing machine, an App 81 for electric cooker, etc. A use may touch the icon of the App 71 for air-conditioner and enter a temperature display and setting screen 78 as shown in FIG. 4B, or enter next page of an air volume display setting screen 79 as shown in FIG. 4C.

Packet Formats for The Control Apps and The Bluetooth Controllable Electrical Appliances

There will be different considerations on packet format for different electrical appliances. Therefore, the packet formats for the control Apps and the Bluetooth controllable electrical appliances should be designed in consideration of various conditions. A preferred packet format for the control Apps and the Bluetooth controllable electrical appliances is as below.

| 1 | 2 | 3 | 4 | 5 | 6 |
|---|---|---|---|---|---|
| Command | No. of a | Types of a | On/Off | Sensor | Value |
| | Bluetooth | Bluetooth | | types | |
| | controllable | controllable | | | |
| | electrical | electrical | | | |
| | appliance | appliance | | | |

1^{st} column (Command): For recognition of a command given to a Bluetooth controllable electrical appliance at home from a control App. When the Bluetooth controllable electrical appliance receives a communication from the control App, it checks the Command column for a specific command such as setting or reporting operation status and reacts accordingly.
2^{nd} column (No. of a Bluetooth controllable electrical appliance): For recognition of different Bluetooth controllable electrical appliances. It may contain the Bluetooth 4.0 address coding which is unique for each Bluetooth communication module.
3^{rd} column (Types of a Bluetooth controllable electrical appliance): For recognition of different types of electrical appliances. For example, air-conditioner may be set to be 0x01 and refrigerator may be set to be 0x02, etc.
4^{th} column (On/Off): For recognition of the On/Off status of a Bluetooth controllable electrical appliance.
5^{th} column (Sensor types): For recognition of different types of sensors.
6^{th} column (Value): Showing the value detected by the sensor specified in the 5^{th} column.

### EXAMPLE 1

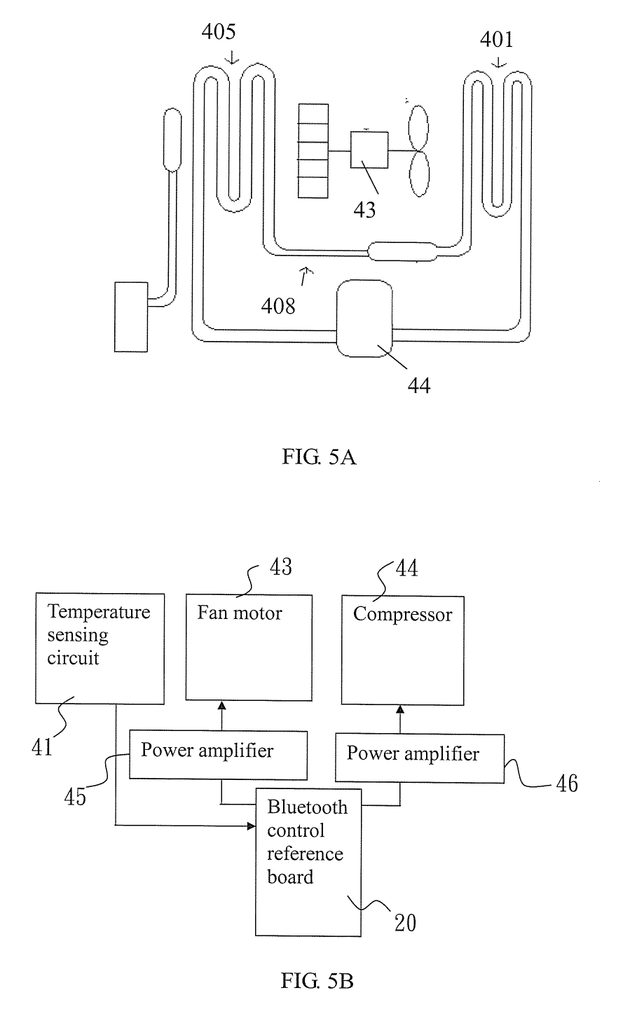

FIG. 5A illustrates the main components of a window-type air-conditioner, and the relations between them. There are four main components: a compressor 44, an evaporator 405, a condenser 401, and a fan motor 43 and an expansion valve (or capillary tube) 408.

FIG. 5B is a system architecture diagram of a Bluetooth controllable air-conditioner according to an embodiment of the present invention. A Bluetooth control reference board 20 is used to control the surrounding control circuit and the Bluetooth module of the Bluetooth controllable air-conditioner. When the Bluetooth control reference board 20 receiving an command from a control App of a mobile device, if the command is a command requesting for status reporting, the status of temperature sensing circuit 41, compressor 44 and fan motor 43 will be transmitted via the Bluetooth 4.0 communication module 252 of the Bluetooth control reference board 20, and if the command is a command for setting, the Bluetooth control reference board 20 will execute the command via PWM output to a power amplifier 45 for driving the fan motor 43, and to a power amplifier 46 for driving the compressor 44.

### EXAMPLE 2

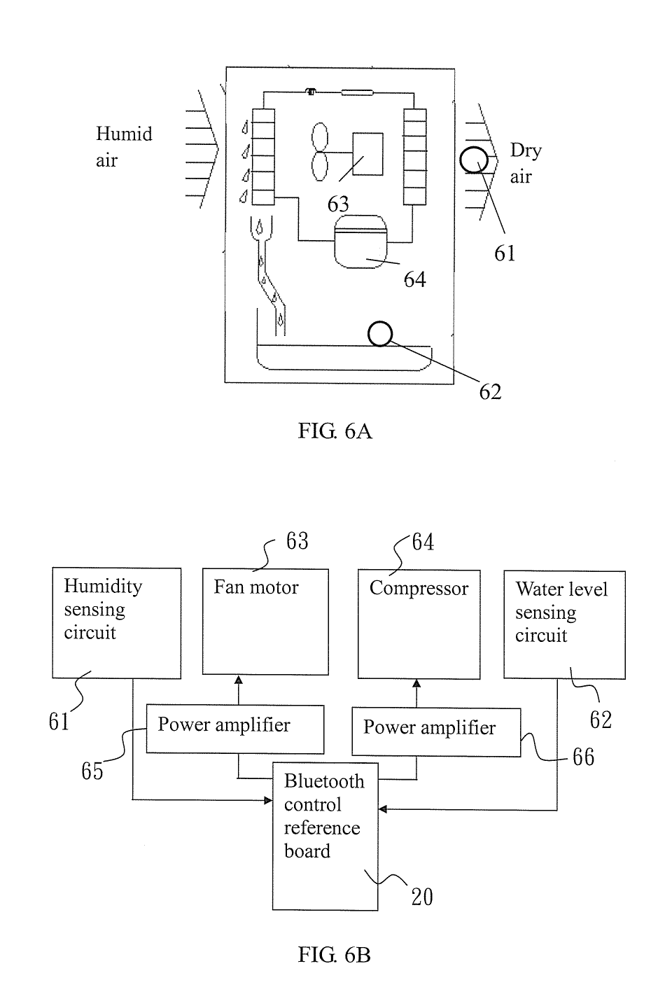

FIG. 6A illustrates the main components of a dehumidifier, and the relations between them. With reference to FIG. 6, the dehumidifier includes, for example, a humidity sensing circuit 61, a water level sensing circuit 62, a fan motor 63, and a compressor 64.

FIG. 6B is a system architecture diagram of a Bluetooth controllable dehumidifier according to an embodiment of the present invention. A Bluetooth control reference board 20 is used to control the surrounding control circuit and the Bluetooth module of the Bluetooth controllable dehumidifier. When the Bluetooth control reference board 20 receiving an command from a control App of a mobile device, if the command is a command requesting for status reporting, the status of humidity sensing circuit 61, water level sensing circuit 62, compressor 64 and fan motor 63 will be transmitted via the Bluetooth 4.0 communication module 252 of the Bluetooth control reference board 20, and if the command is a command for setting, the Bluetooth control reference board 20 will execute the command via PWM output to a power amplifier 65 for driving the fan motor 63, and to a power amplifier 66 for driving the compressor 64.

### EXAMPLE 3

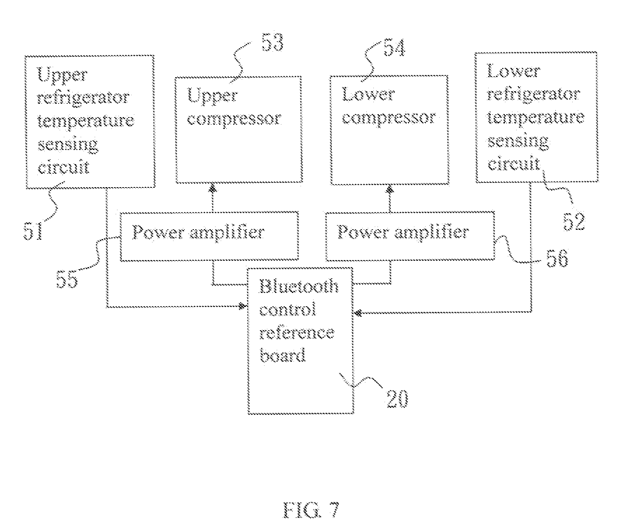

FIG. 7 is a system architecture diagram of a Bluetooth controllable refrigerator according to an embodiment of the present invention. A Bluetooth control reference board 20 is used to control the surrounding control circuit and the Bluetooth module of the Bluetooth controllable dehumidifier. When the Bluetooth control reference board 20 receiving an command from a control App of a mobile device, if the command is a command requesting for status reporting, the status of an upper refrigerator temperature sensing circuit 51, a lower refrigerator temperature sensing circuit 52, an upper compressor 53 and a lower compressor 54 will be transmitted via the Bluetooth 4.0 communication module 252 of the Bluetooth control reference board 20, and if the command is a command for setting, the Bluetooth control reference board 20 will execute the command via PWM output to a power amplifier 55 for driving the upper compressor 53, and to a power amplifier 56 for driving the lower compressor 54.

### EXAMPLE 4

For a Hotel, a password in connection with a specific room can be provided when a guest is checking in. The guest may then enter the password into his/her mobile phone and use it for opening the door of the room and for controlling Bluetooth controllable electrical appliances in the room. No keys or magnetic cards are required. The Bluetooth 4.0 ID in the mobile phone is also applicable on parking and debit payment for the same.

Although Bluetooth 4.0 is used in the above examples, Bluetooth 4.0 or later protocols may be used in the present invention.

The above-disclosed preferred embodiments of the present invention are not intended as limitations to the present invention. Those skilled in the art of the present invention should be able to make changes and modifications within the spirit and scope of the present invention, and such changes and modifications would fall within the protected scope of the present invention as defined by the appended claims.

What is claimed is:

1. A Bluetooth controllable electrical appliance, comprising:
a circuit substrate;
a Bluetooth communication, chip disposed on the circuit substrate, where the Bluetooth communication chip is compatible with a Bluetooth 4.0 or later protocol and is able to communicate with an external remote controller compatible with the Bluetooth 4.0 or later protocol;
a microcontroller disposed on the circuit substrate and electrically connected to the Bluetooth communication chip, for receiving a command from the external remote controller via the Bluetooth communication chip and reporting a status of use of the Bluetooth controllable electrical appliance, wherein the microcontroller supplies at least one output selected from the group consisting of a PWM output, a DAC command output and a digital switch output;
an AC to DC circuit disposed on the circuit substrate, for converting AC electricity supplied to the Bluetooth controllable electrical appliance to the DC electricity required by the Bluetooth communication chip and the microcontroller; and
one or more actuators selected horn the group consisting of a motor, a heating coil, resistor or transistor, and a combination thereof, wherein the one or more actuators are connected to and driven by a power amplifier or a relay, the power amplifier or the relay being regulated by the at least one output supplied by the microcontroller.

2. The Bluetooth controllable electrical appliance according to claim 1, wherein the one or more actuators are one or more motors, and the Bluetooth, controllable electrical appliance is an appliance selected from the group consisting of an electric fart, a dehumidifer, an air cleaner, an air conditioner a juice machine, a vacuum cleaner, a refrigerator, a dishwasher, a microwave oven, an electric curtain, an electric bed, an elevator, an electric door, and an electric massage chair.

3. The Bluetooth controllable electrical appliance according to claim 1, wherein the one or more actuators arc one or more heating coils, resistors or transistors, and the Bluetooth controllable electrical appliance is an appliance selected from the group consisting of a microwave, a lamp, a LED lamp, an electric cooker, an electric oven, and an induction cooker.

4. The Bluetooth controllable electrical, appliance according to claim 1, wherein the external remote controller compatible with the Bluetooth 4.0 or later protocol is a device selected from the group consisting of a mobile phone, a tablet computer, a laptop computer, and a desktop computer, said device having an App for remote controlling installed therein.

5. The Bluetooth controllable electrical appliance according to claim 1, further comprising a feedback sensor selected from the group consisting of an encoder, a thermometer, a tachometer, a hygrometer, an illuminance meter, and a microphone.

6. The Bluetooth controllable electrical appliance according to claim 1, wherein the Bluetooth controllable electrical appliance is a LED light source and the microcontroller have a control program installed therein, said control program providing a feedback signal to the external remote controller via a gateway and a router compatible with Bluetooth 4.0 or later protocol communication and WIFI communication.

7. The Bluetooth controllable electrical appliance according to claim 1, wherein the Bluetooth communication chip and the microcontroller are integrated in a system on chip (SOC).

8. A. Bluetooth controllable electrical appliance, comprising:
a circuit substrate;
a Bluetooth communication, chip disposed on the circuit substrate, wherein the Bluetooth communication chip is compatible with a Bluetooth 4.0 or later protocol and is able to communicate with an external remote controller compatible with the Bluetooth 4.0 or later protocol;
a microcontroller disposed on the circuit substrate and electrically connected to the Bluetooth communication, chip, for receiving a command from the external remote controller via the Bluetooth communication chip and reporting a status of use of the Bluetooth controllable electrical appliance, wherein the microcontroller supplies at least one output selected from the group consisting of a PWM output, a DAC command output and a digital switch output; and
an AC to DC circuit disposed or; the circuit substrate, tor converting AC electricity supplied to the Bluetooth controllable electrical appliance to the DC electricity required by the Bluetooth communication chip and the microcontroller

9. The Bluetooth controllable electrical appliance according to claim B, which is selected from the group consisting of a Stereo, a TV, a DVD player, a VCR, a karaoke OK, a projector, and a set-ton box.

10. The Bluetooth controllable electrical appliance according to claim 8, wherein the external remote controller compatible with the Bluetooth 4.0 or later protocol is a device selected from the group consisting of a mobile phone, a tablet computer, a laptop computer, and a desktop computer, said device having an App for remote controlling installed therein.
